(19) United States
(12) Patent Application Publication
(10) Pub. No.: US 2003/0188041 A1
(43) Pub. Date: Oct. 2, 2003

(54) Distributed event notification system and method

(76) Inventor: James A. Fillmore, Post Falls, ID (US)

Correspondence Address: WELLS ST. JOHN P.S., 601 W. FIRST AVENUE, SUITE 1300, SPOKANE, WA, 99201, US

(21) Appl. No.: 10/113,082

(22) Filed: Apr. 1, 2002

(51) Int. Cl. G06F 9/46

(52) U.S. Cl. 709/318

(57) ABSTRACT

A distributed event notification system is provided having a master device, at least one slave device, and a communication link. The master device has a transmitter, processing circuitry, and an interface. The interface communicates with a local area network (LAN) and is configured to enable the master device to receive notification of events from one or more external event managers. The at least one slave device has a receiver and a user display. The communication link interconnects the transmitter of the master device with the receiver of the at least one slave device. The master device transmits a packet of information from the master device to one or more slave devices via the communication link. The packet of information is indicative of the notification of an event. A method is also provided.

### TECHNICAL FIELD

This invention pertains to event notification devices. More particularly, this invention relates to a distributed event notification system for a local area, such as a local area network.

### BACKGROUND OF THE INVENTION

Internet connectivity has enabled large groups of users to access personal applications such as electronic mail (e-mail) and appointments using individual personal computers (PCs). For many users in developed countries, the gathering of information via e-mail and electronic appointments has become quite routine. E-mail is a particularly convenient technique for notifying a user because message delivery is nearly instantaneous. At the same time, e-mail is not nearly as intrusive to a user as is a voice telephone call. As a result, more and more people are using e-mail. However, the effectiveness of e-mail is substantially reduced when a personal computer (PC) is not immediately available to a user. For example, many users maintain a personal computer within one room of their home. Accordingly, event notification can only occur when the user is in such room, and furthermore, when the user has logged into their computer and retrieved any e-mail.

The number of persons using personal appointment scheduling software is likely to increase if users are no longer required to be present at their personal computers (PCs) in order to benefit from entering appointments into their PCs. Accordingly, there exists a need for a system and method for notifying users that are remote from their PCs of the occurrence of one or more events.

One technology presently available for providing information to users that are remote from PCs uses mobile telephones, pagers, or wireless personal digital assistants (PDAs). More particularly, many persons carry such small, dedicated devices in order to stay constantly connected with the world. However, these devices require the user to maintain a service contract with a wireless communications provider, wherein there is a user fee that is directly proportional with the amount of time that the device is used. The costs for providing a service contract for each member of a family can significantly prohibit the use of such devices by every member of a family. Hence, users are reluctant to casually use such devices, particularly within a home environment. Secondly, such devices are worn or carried by the user which burdens the user and increases the likelihood that such devices can be dropped and broken.

Accordingly, there remains a need to improve event notification for multiple users within a local or regional environment such as within a home, office or local area.

### BRIEF SUMMARY OF THE INVENTION

According to one aspect, a distributed event notification system is provided having a master device, at least one slave device, and a communication link. The master device has a transmitter, processing circuitry, and an interface. The interface communicates with a local area network (LAN) and is configured to enable the master device to receive notification of events from one or more external event managers. The at least one slave device has a receiver and a user display. The communication link interconnects the transmitter of the master device with the receiver of the at least one slave device. The master device transmits a packet of information from the master device to one or more slave devices via the communication link. The packet of information is indicative of the notification of an event.

According to another aspect, a method is provided for notifying a recipient present within a local area of the occurrence of an event. The method includes: providing a master device and at least one slave device distributed within the local area and communicating with the master device; receiving notification of occurrence of an event at the master device; identifying at least one recipient for whom notification of the occurrence of the event is desired; for the identified recipient, comparing the event with predefined selection criteria to determine if the event is a desired event; if the event is a desired event, broadcasting a notification of the occurrence of the event to the at least one slave device from the master device; and displaying indicia at the at least one slave device via a respective visual display in an effort to notify the recipient of the occurrence of the event.

According to yet another aspect, a method is provided for displaying specific event notifications to a user within a local area network (LAN). The method includes: providing a plurality of slave devices each comprising a plurality of indicia arranged to provide an event notification display distributed remotely within a local area network environment along with a master device that communicates with each of the slave devices via a communication link; receiving notification at the master device from an external source of the occurrence of a specific event; generating indicia update information via the master device in response to notification of the occurrence of the specific event; broadcasting the indicia update information from the master device to each of the slave devices; receiving the indicia update information at each of the slave devices; and displaying the indicia at each of the slave devices in response to receiving the indicia update information.

According to even another aspect, a method is provided for displaying specific event notifications to a user within a local area network (LAN). The method includes: providing a plurality of slave devices each comprising a plurality of indicia arranged to provide an event notification display distributed remotely within a local area network environment along with a master device that communicates with each of the slave devices via a communication link; receiving notification at the master device from an external source of the occurrence of a specific event; generating indicia update information via the master device in response to notification of the occurrence of the specific event; broadcasting the indicia update information from the master device to each of the slave devices; receiving the indicia update information at each of the slave devices; and displaying the indicia at each of the slave devices in response to receiving the indicia update information.

One advantage results because a provided event notification system is capable of notifying a plurality of users distributed within a local area of events without requiring that each user maintain a service contract for a connected computer or mobile communication device.

### BRIEF DESCRIPTION OF THE DRAWINGS

Preferred embodiments of the invention are described below with reference to the following accompanying drawings.

FIGS. 1A-1B, assembled as in FIG. 1, together form a block diagram overview of a basic system configuration for an exemplary event notification system for implementing distributed event notification according to one embodiment of the present invention.

FIG. 2 is a simplified perspective view of a slave device displaying indicia via a visual display to notify an identified recipient of the occurrence of an event.

FIG. 3 is a block diagram illustrating transmission of an exemplary packet (of one or more packets) of information to a slave device (of one or more slave devices).

FIGS. 4A-4B, assembled as in FIG. 4, together form a block diagram overview for another exemplary event notification system for implementing distributed event notification according to another embodiment of the present invention.

FIG. 5 is a process flow diagram showing the logic processing for notifying a recipient present within a local area of the occurrence of an event according to one embodiment of the present invention.

FIG. 6 is a process flow diagram showing the logic processing for displaying specific event notifications to a user within a local area network (LAN) according to another embodiment of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Reference will now be made to a preferred embodiment of Applicant's invention. Two exemplary implementations are described below and depicted with reference to the drawings each comprising a distributed event notification system. While the invention is described by way of multiple embodiments, it is understood that the description is not intended to limit the invention to such embodiments, but is intended to cover alternatives, equivalents, and modifications which may be broader than the embodiments, but which are included within the scope of the appended claims.

In an effort to prevent obscuring the invention at hand, only details germane to implementing the invention will be described in great detail, with presently understood peripheral details being incorporated by reference, as needed, as being presently understood in the art.

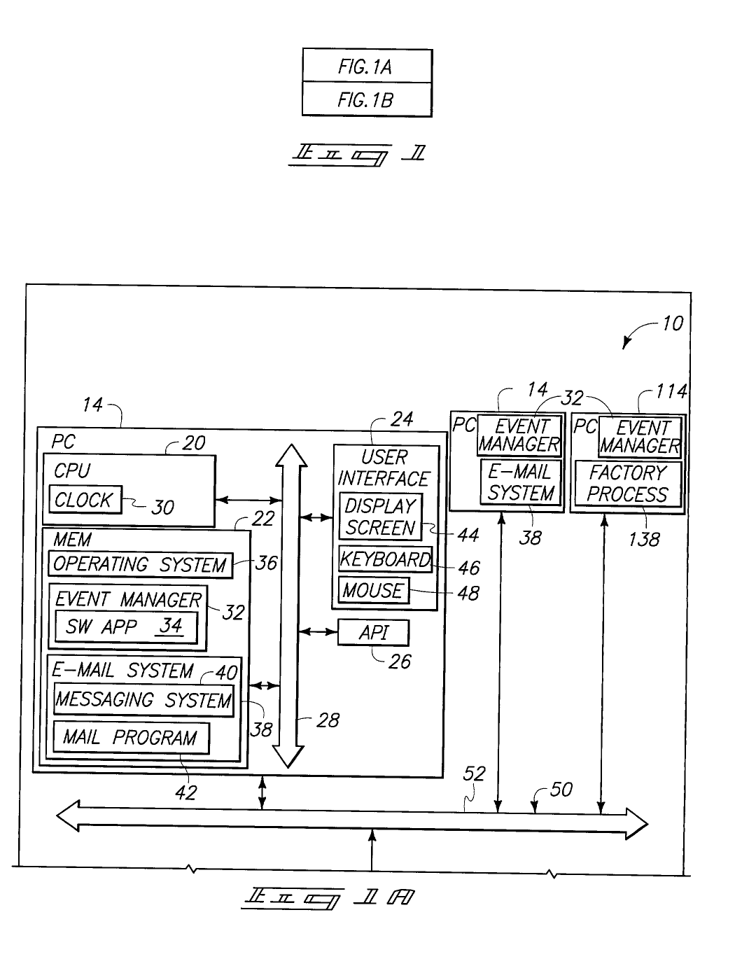

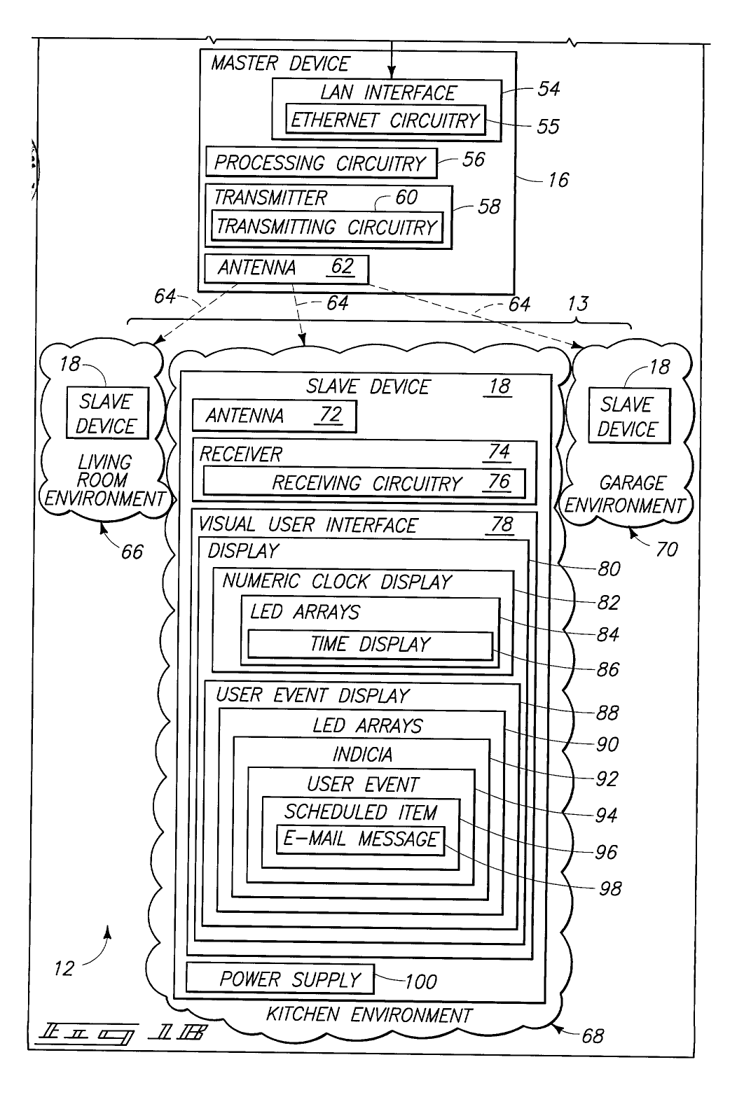

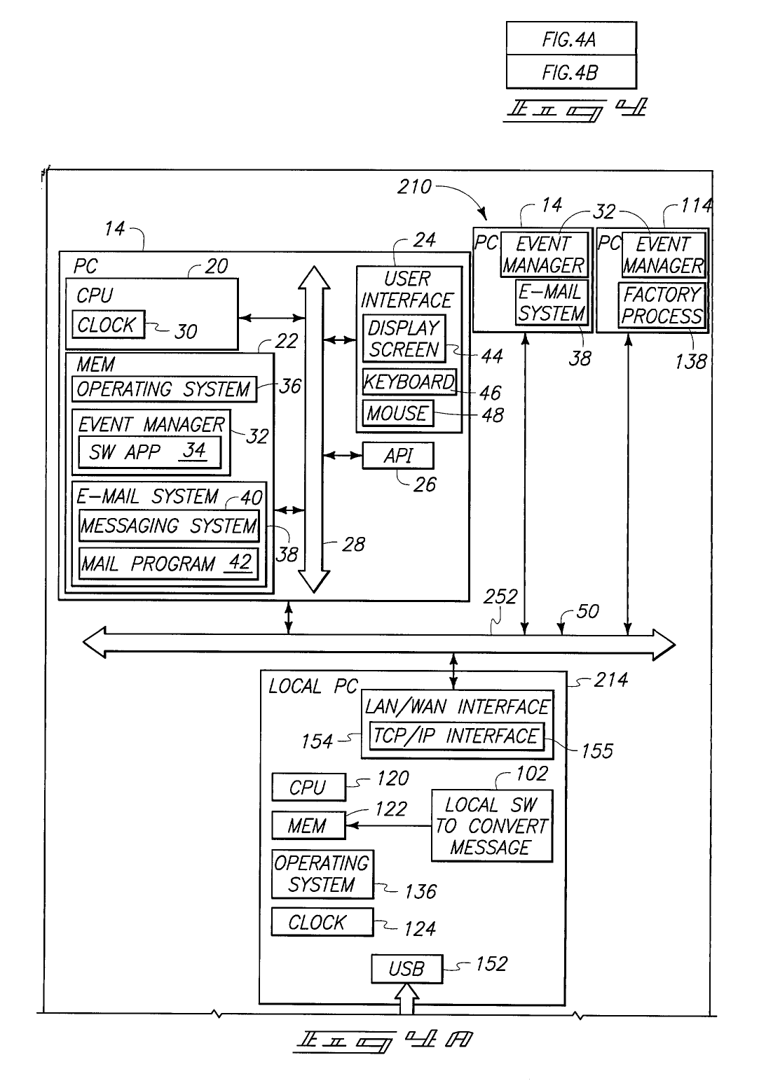

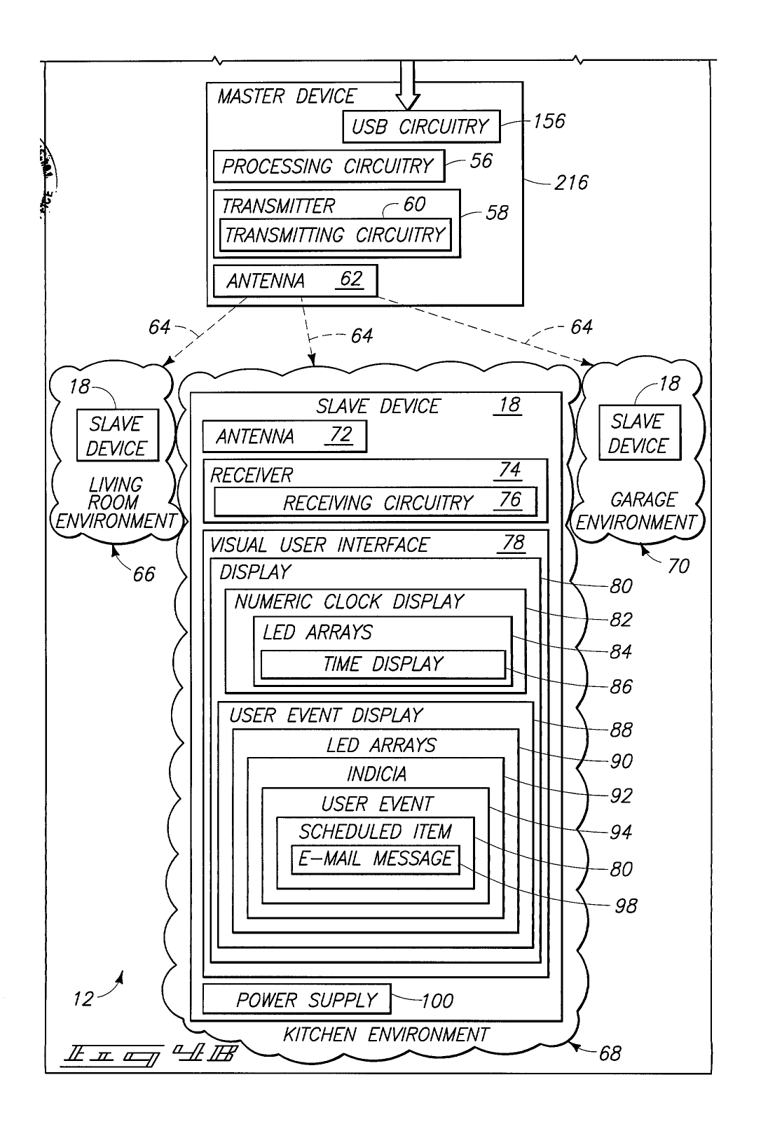

FIG. 1 illustrates a preferred embodiment of the present invention wherein a basic system configuration is provided for displaying indicia in a distributed manner in an effort to notify one or more recipients of the occurrence of one or more events, and is identified with reference numeral 10. In one form, distributed event notification system 10 is provided within a local area network (LAN) environment 12. However, it is understood that system 10 can also be implemented with master and slave devices within a local area network and with PCs and associated event managers coupled with the local area network via a wide area network as shown in the embodiment depicted in FIG. 4.

The embodiment depicted in FIG. 1 is best suited for environments that have Ethernet access, and is typically better for commercial applications, or local area environments that include a cable modem or a Digital Subscriber Line (DSL). Alternatively, the embodiment depicted in FIG. 4 is well-suited for environments utilizing a Universal Serial Bus (USB) interconnect, where there is no Ethernet connectivity available.

As shown in FIG. 1, system 10 includes a plurality of personal computers (PCs) 14 and 114 configured to communicate with a master device 16. Master device 16 is configured to communicate with at least one slave device 18 from a plurality of slave devices 18 distributed within a local area, such as LAN environment 12. In one case, every slave device 18 receives a broadcast of a notification of the occurrence of an event from master device 16. Alternatively, a selected one or more of the slave devices 18 receives such a broadcast.

As shown in FIG. 1, computers in the form of PCs 14 and 114 communicate with master device 16 so that master device 16 can receive notification of the occurrence of an event. Master device 16 identifies at least one recipient for whom notification of the occurrence of the event is desired. For the identified recipient, master device 16 compares the event with predefined selection criteria in order to determine if the event is a desired event. If the event is determined to be a desired event, notification of the occurrence of the event is broadcast to at least one of slave devices 18. Preferably, notification of the occurrence of the event is broadcast to all of slave devices 18 distributed within LAN environment 12. Master device 16 communicates with each slave device 18 to enable such slave devices 18 to display indicia in an effort to notify one or more recipients of the occurrence of the event. In this manner, a recipient within LAN environment 12 can be notified of the occurrence of a desired event.

Additionally, master device 16 and/or PCs 14 and/or 114 can detect the occurrence of an event. System 10 is illustrated in FIG. 1 as having three distinct remote PCs 14 and 114. However, it is understood that a minimum configuration can comprise a single PC 14. For example, PC 14 can comprise a single PC located in a user's home. Alternatively, multiple PCs 14 and 114 can be deployed within a small office environment. According to such alternative embodiment, each PC can include an event manager, similar to event manager 32 (described further below).

As illustrated in FIG. 1, PCs 14 and 114 each include an event manager 32. However, PCs 14 are configured with an e-mail system 38, whereas PC 114 is configured with a factory process 138. Factory process 138 comprises a technique for monitoring critical parameters or states of a production environment. In one case, PC 114 receives feedback from a factory process using a sensor (not shown) to monitor a condition in the factory process. Several examples are given below, including the configuration of a thermal sensor for measuring the temperature environment for a local area server.

PCs 14, according to one construction, comprise PCs within a small office environment. More particularly, PCs 14 include a central processing unit (CPU) 20, memory 22, user interface 24, application program interface (API) 26, and bus 28. One exemplary bus 28 comprises a local bus such as a PCI bus.

Within PC 14, CPU 20 includes a clock 30. Memory 22 is configured to contain event manager 32, an operating system 36, and an e-mail system 38. Event manager 32 includes a software application, such as software that monitors PCs, servers, workstations and network drives for routine events (such as log-ons) and non-routine events (such as component failures). E-mail system 38 includes a messaging system 40 and a mail program 42.

User interface 24 of PC 14 includes a display screen 44, a keyboard 46, and a mouse 48.

As shown in FIG. 1, each PC 14 is similarly constructed. However, a second PC 14 is only illustrated as containing event manager 32 and e-mail system 38 in order to simplify the drawings, even though it is understood that such PC 14 includes the same components as the first PC 14.

PC 114 includes an event manager 32 and factory process 38. More particularly, PC 114 is a dedicated computer configured to monitor a factory process. For example, one application for PC 114 is configured to provide technical support for a network. By way of example, a temperature gauge can be provided within a server room of a network. PC 114 can be configured to monitor such temperature gauge so as to notify a recipient of the occurrence of a desired event such as an abnormally high temperature within a room in which the server is stored. Accordingly, factory process 138 comprises software that monitors such sensor and compares temperature values with predefined temperature values indicating a threshold temperature above which damage might occur to the server.

Alternatively, factory process 138 comprises a sensor that monitors a carrier signal for a wireless T1 interface (a point-to-point dedicated digital line interface provided by telephone carriers) that is provided for a server within the local area network.

PCs 14 and 114 are coupled by a communication link with master device 16. In one form, communication link 50 comprises an Ethernet local area network (LAN) 52. It is understood that Ethernet LAN 52 may comprise switches arrayed in a star configuration with an Ethernet hub, according to one construction.

More particularly, master device 16 includes a local area network (LAN) interface 54, processing circuitry 56, transmitter 58, and transmitting antenna 62. In one form, LAN interface 54 is an Ethernet interface comprising Ethernet circuitry 55 that communicates with a local area network (LAN). Transmitter 58 includes transmitting circuitry 60. Optionally, master device 16 can include a receiver comprising receiving circuitry, whereas antenna 62 is also configured as a receiving antenna. Interface 54 is configured to enable master device 16 to receive notification of events from one or more external event managers, such as event manager 32.

Furthermore, communication link 50 interconnects transmitter 58 of master device 16 with the receiver 74 of at least one slave device 18. Master device 16 transmits a packet of information from master device 16 to one or more of slave devices 18 via communication link 50, with the packet of information being indicative of the notification of an event. In one case, communication link 50 includes a wired network link, transmitter 58 includes a serial interface, and receiver 74 includes a serial interface. In another case, communication link 50 includes a radio frequency (RF) wireless network link, transmitter 58 includes a transmitting antenna 62 and transmitting circuitry 60, and receiver 74 includes a receiver antenna 72 and receiving circuitry 76.

In operation, master device 16 compares an event from PC 14 and/or 114 with predefined selection criteria in order to determine if the event is a desired event. Such comparing comprises filtering the event in order to verify that the event is a desired event that necessitates notification of the recipient in response to occurrence of the event. By way of example, an event can comprise a high priority e-mail being received at PC 14 for a designated recipient. A desired event can comprise receipt and dissemination of such a priority e-mail for a designated recipient at PC 14. Accordingly, lower level priority e-mails do not comprise desired events that necessitate notification of the recipient. According to such exemplary configuration, only higher priority e-mails will necessitate notification of the specific recipient at slave devices 18.

As shown in FIG. 1, master device 16 communicates by way of a plurality of wireless radio frequency (RF) communication links 64 to each slave device 18. One slave device 18 is present within a living room environment 66 of a residence. Another slave device 18 is present within a kitchen environment 68 of such residence. Yet another slave device 18 is present within a garage environment 70 of such residence. Environments 66, 68, and 70 are provided within a local area 13 of such residence. However, it is understood that local area 13 can be distributed within one or more proximate buildings of a local area, such as within a garage, shop, and/or home of a residence; or within multiple proximate buildings on a university campus or within a business environment.

As shown in FIG. 1, each slave device 18 includes a wireless receiving antenna 72, a receiver 74, a visual user interface 78, and a power supply 100. Receiver 74 comprises receiving circuitry 76 that couples with receiving antenna 72 for receiving a broadcasted notification of a desired event from transmitting antenna 62 of master device 16 via an RF communication link 64. Optionally, a transmitter can also be provided within a slave device and a transmitting antenna for transmitting information back to master device 16 and forwarding on to PCs 14 and/or 114.

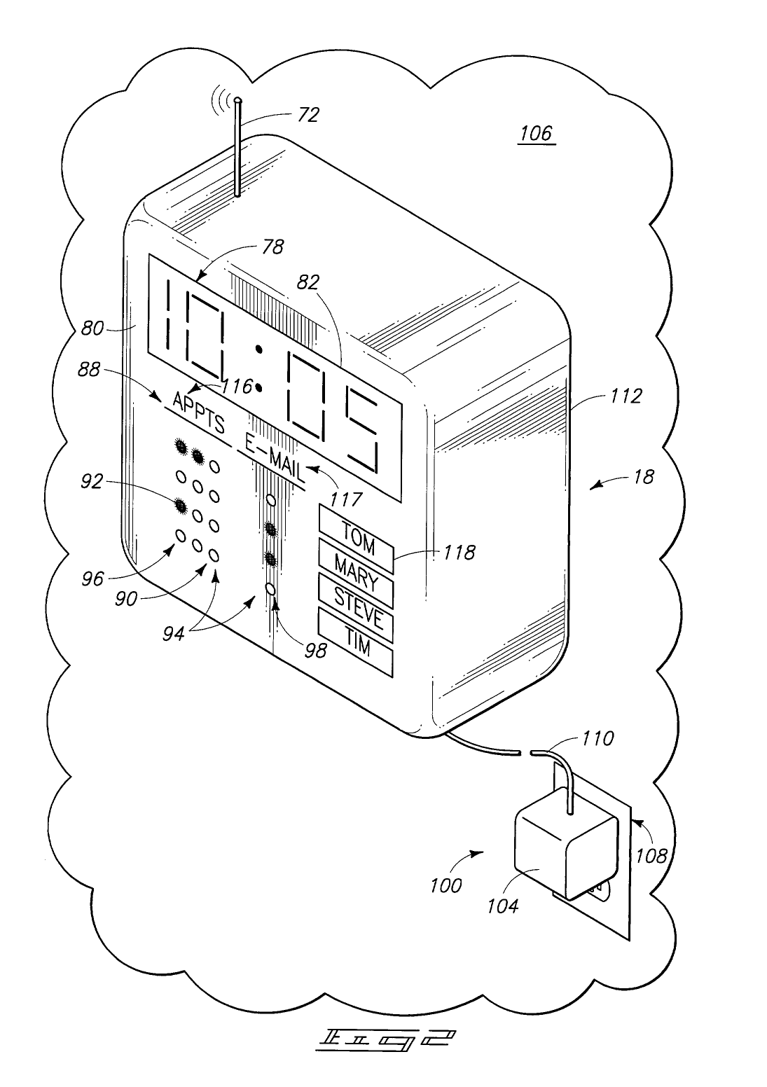

Visual user interface 78 includes a display 80 and a user event display 88. Display 80 includes a numeric clock display 82 having LED arrays 84 including a time display 86. User event display 88 includes LED arrays 90, each including indicia 92. Indicia 92 are selectively configured to indicate a user event 94. One user event 94 comprises a scheduled item 96 including notification of the generation and/or receipt of a particular e-mail message 98 for a designated recipient or recipients. Further details of slave device 18 are depicted below with reference to FIG. 2.

One embodiment depicted in FIG. 2 further illustrates an exemplary construction for slave device 18. Such slave device 18 is provided with an alternating current (AC) transformer 104 which supplies power for slave device 18 from an AC wall outlet 108 on a wall 106 of a residence or building. AC transformer 104 communicates via a power supply line 110 with slave device 18 to provide power to slave device 18.

Slave device 18 includes a housing 112, with visual user interface 78 being provided in a front face of housing 112. Numeric clock display 82 of display 80 is shown in an upper portion of housing 112. Additionally, LED arrays 90 of user event display 88 are shown in the lower portion of housing 112. Individual LEDs are selectively illuminated to provide indicia 92 that indicate a desired user event 94 such as a scheduled item 96. Additionally, another scheduled item can comprise notification of an e-mail message 98 for a selected desired recipient. A selected desired recipient (or user) is evidenced by a user identification (ID) tag 118 provided in a row adjacent to associated indicia. One indicia is represented by an indicia descriptor 116 for appointments and another indicia is represented by an indicia descriptor 117 for e-mail notification.

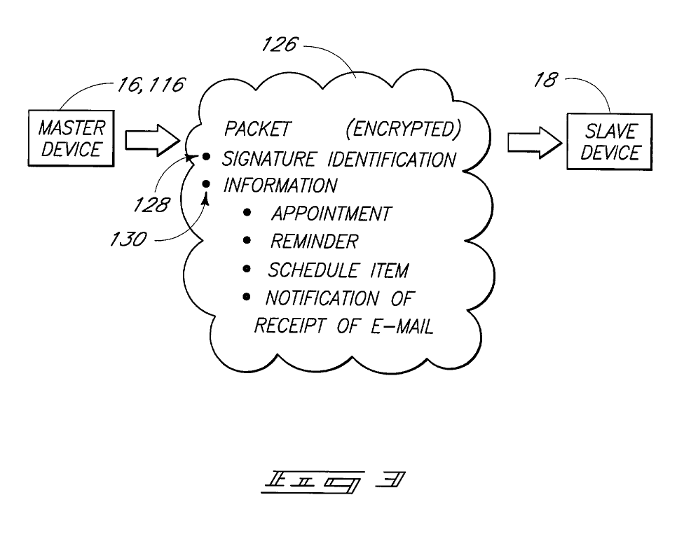

FIG. 3 illustrates broadcast of notification of a desired event from a master device 16 (of FIG. 1) or master device 116 (of FIG. 4) to slave device 18. More particularly, notification of a desired event is broadcast by transmitting at least one packet of information 126 from master device 16 or 116 to slave device 18. According to one implementation, the packet of information 126 is transmitted from a radio frequency (RF) transmitter to a radio frequency (RF) receiver (as shown in FIG. 1). At least one packet of information 126 comprises a signature identification 128 that is operative to validate master device 16 or 116 and the packet of information. The packet of information is transmitted after the signature identification 128. Information 130 can comprise an appointment for a recipient, a reminder for a recipient, a scheduled item for a recipient, and/or a notification of receipt of an e-mail for a designated recipient. Further alternative information can also be provided within packet 126.

In operation, it is understood that a plurality of packets 126 are transmitted from a master device to a slave device. Even furthermore, it is understood that packet of information 126 is desirably encrypted.

Accordingly, the embodiment depicted in FIGS. 1-3 illustrates a system and method for posting events that are detected by one or more external event managers to a plurality of recipients or users by way of user displays on a plurality of slave devices. The slave devices and their corresponding user displays are constructed to be relatively non-obtrusive (as shown in FIG. 2) so that users will be willing to place them in multiple convenient locations within a local area. Accordingly, the non-obtrusive nature and relatively low cost construction will increase the likelihood and ease with which recipients will be informed or notified about the occurrence of a desired event.

According to the preferred embodiment depicted in FIGS. 1-3, the slave devices include clocks. Visual clocks are items that are traditionally accepted for placement in multiple rooms within a home or office. Accordingly, individuals naturally look at clocks in order to inform themselves of the present time of day. The device depicted in FIG. 2 is similarly constructed, yet such device provides additional information integrated into the unit that will notify users of desired events, such as reception of e-mail or appointments for a targeted recipient. Accordingly, the presentment of such additional information and the manner of distributing presentment of the information within a home or office will be more useful, convenient and relatively non-obtrusive.

According to one instance that uses the device of FIGS. 1-3, indicia are displayed to a recipient by illuminating selected individual light-emitting diodes within an array of light-emitting diodes on one or more of the slave devices in order to notify a recipient of priority e-mail. Unfortunately, people generally receive an oversupply of e-mail. Accordingly, event managers on remote computers are user programmed in order to select e-mail that is of higher interest to the user (priority e-mail). The master device is programmed to only post the receipt of priority (or selected) e-mail to recipients. As a further optional configuration, multiple indicia may be utilized in order to inform recipients of the receipt of e-mail having different relative levels of importance (or priority). For example, one diode can be illuminated in order to represent general e-mail, whereas another diode can be illuminated in order to represent urgent company e-mail, and a third diode can be illuminated in order to represent the receipt of personal e-mail. It is understood that further optional configurations of illuminated diodes or indicia can be utilized in order to notify one or more recipients of the occurrence of desired events.

According to the device depicted in FIGS. 1-3, several techniques are utilized in order to reconfigure the display of indicia by turning the light-emitting diodes off. In one case, a recipient reads his/her e-mail, after which an event manager monitors when the recipient reviews such e-mail, thereby turning off the corresponding LED on the slave device. In another case, the recipient reads his/her e-mail, then sends an explicit message to the event manager, directing the event manager to initiate turning off the LED such that the illuminated indicia are no longer displayed to a recipient. Accordingly, such reconfiguration (or turning off) of indicia can occur explicitly or implicitly. Another case entails the turning off of LEDs when the time for an appointment to occur has expired. For example, the event manager can be configured to turn off a corresponding “appointment” LED one hour after the time for the scheduled appointment has occurred. Alternatively, the LED can be turned off at a time exactly corresponding with the time of the appointment. Further alternatively, the turning off of the LED can correspond with midnight following the day in which the appointment occurred.

Furthermore, it is understood that other applications exist for monitoring critical equipment via PC 114 having an event process 148. For example, clerical systems components such as computer servers, telephone networks, and/or plant equipment can be monitored in order to determine proper functioning of such critical system components. The malfunctioning or undesirable performance of components of such critical systems can be posted in parallel, and concurrently on slave devices and distributed throughout a local area, such as a home or office. Such dissemination of a desired event is carried out within a local area without having to maintain a service contract, as is required when using a beeper, pager, wireless personal digital assistant (PDA), and/or cellular telephone.

Other examples of applications for monitoring critical systems include the functioning of smoke detectors or carbon monoxide detectors within a residence. The detection of a malfunction of such a detector can comprise a desired event requiring notification within the local area of one or more recipients of the malfunction of such detector. It is understood that the provision of an API 26 within PC 14 enables configuration in order to detect new events relating to the monitoring of new critical equipment in different and unique environments. Accordingly, such a configuration can be enabled such that implementation is not dependent on a specific operating system. Hence, users of Applicant's device can fine tune or develop entirely new applications for slave devices by merely labeling changes that are required.

It is anticipated that an API used to interface with the master device will be published for public dissemination in order to simplify and encourage utilization of the system for developing new applications. Accordingly, usefulness of the present invention and other computer-based applications will increase because users are enabled with the ability to deploy non-obtrusive devices about their homes or offices that will notify them of desired events that were detected by their personal computer.

FIG. 4 illustrates an alternative embodiment of the present invention comprising a basic system configuration for displaying indicia in a distributed manner to notify one or more recipients of the occurrence of one or more events, and as identified with reference numeral 210. In this exemplary form, event notification system 210 is provided within a combined local area network/wide area network (LAN/WAN) environment 212.

As shown in FIG. 4, system 210 includes a plurality of personal computers (PCs) 14 and 114 configured to communicate with a master device 216 via a local personal computer (PC) 214. Master device 216 is then configured to communicate with at least one slave device 18 from a plurality of slave devices 18 distributed within a local area, such as the local area network within LAN/WAN 212. As was the case with the embodiment in FIG. 1, every slave device receives a broadcast of a notification of the occurrence of an event from master device 216. Furthermore, slave devices 18 are provided discretely within a living room environment 66, a kitchen environment 68, and a garage environment 70. The slave devices 18 of FIG. 4 are substantially identical to those depicted in the embodiment of FIG. 1. Additionally, PCs 14 are also constructed in a manner similar to those depicted in the embodiment of FIG. 1.

A significant difference between the embodiment depicted in FIG. 4 and that depicted in FIG. 1 is provided by the introduction of a local PC 214, placed between PCs 14, 114 and master device 216.

Local PC 214 communicates via communication link 50 in the form of a Transmission Control Protocol/Internet Protocol (TCP/IP) 252 interface, with PCs 14 and 114. Local area network transmission is then provided between local PC 214 and master device 216 utilizing either USB interconnection or a serial port. As shown in FIG. 4, local PC 214 is connected using a Universal Serial Bus (USB) hardware interface 152 with master device 216 via USB circuitry 156.

As shown in FIG. 4, local PC 214 Interfaces with PCs 14 and 114 via a LAN/WAN interface 154 including a TCP/IP interface 155. PC 214 also includes a central processing unit (CPU) 120, memory 122, an operating system 136, and a clock 124. Furthermore, local software 102 is provided for converting a message, and is stored in memory 122. With respect to TCP/IP interface 155, TCP/IP provides a software protocol for passing information. Master device 216 includes USB circuitry 156, processing circuitry 56, a transmitter 58 (including transmitting circuitry 60), and an antenna 62.

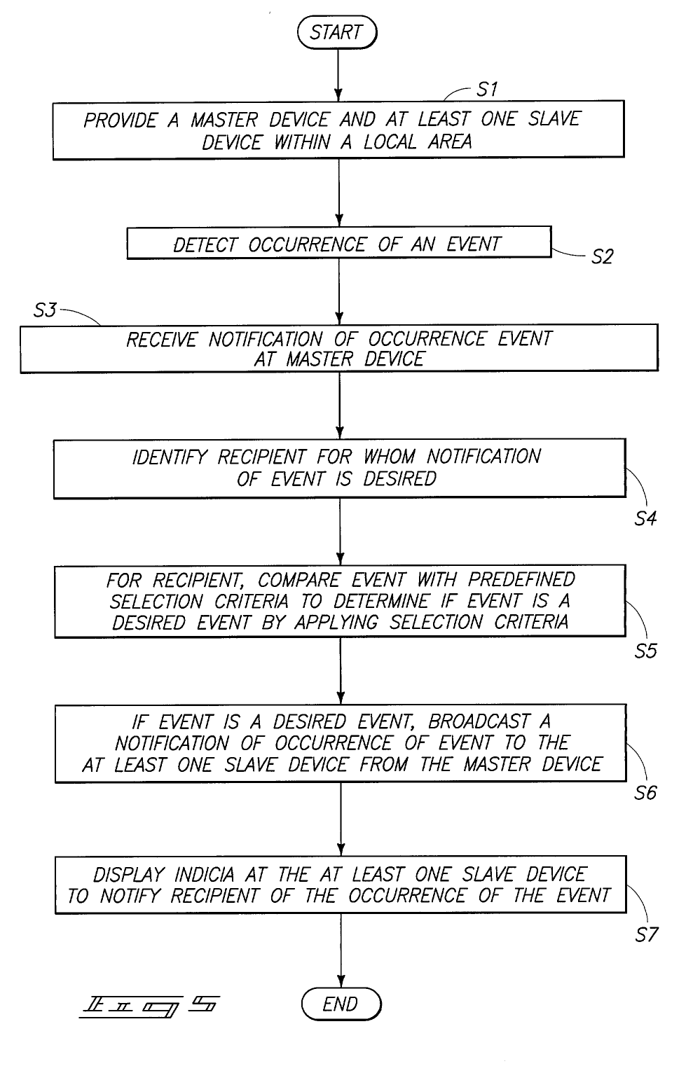

FIG. 5 illustrates, by way of example, one method for notifying a recipient present within a local area of the occurrence of an event. As shown in FIG. 5, a logic flow diagram illustrates the steps of implementing distributed event notification within a local area.

In Step “S1”, the master device and at least one slave device are provided, with the at least one slave device distributed within a local area and communicating with the master device. After performing Step “S1”, the process proceeds to Step “S2”.

In Step “S2”, the system detects the occurrence of an event. After performing Step “S2”, the process proceeds to Step “S3”.

In Step “S3”, the system receives a notification of the occurrence of an event at the master device. After performing Step “S3”, the process proceeds to Step “S4”.

In Step “S4”, the system identifies at least one recipient for whom notification of the occurrence of the event is desired. After performing Step “S4”, the process proceeds to Step “S5”.

In Step “S5”, the system, for the identified recipient, compares the event with predefined selection criteria in order to determine if the event is a desired event. The comparison is implemented by filtering the event. More particularly, the filtering is implemented by applying selection criteria to the event in order to verify the event as a desired event that necessitates notification of the recipient in response to occurrence of the event. After performing Step “S5”, the process proceeds to Step “S6”.

In Step “S6”, if the event is a desired event, the system broadcasts a notification of the occurrence of the event to the at least one slave device from the master device. More particularly, the system broadcasts by transmitting at least one packet of information from the master device to the slave device. Even more particularly, the packet of information is transmitted from a radio frequency (RF) transmitter to a radio frequency (RF) receiver.

After performing Step “S6”, the process proceeds to Step “S7”.

In Step “S7”, the system displays indicia representing a scheduled item for a recipient at the at least one slave device via a respective visual display. Accordingly, display of the indicia is implemented in an effort to notify the recipient of the occurrence of the event by illuminating selected individual light-emitting diodes (LEDs) within an array of light-emitting diodes (LEDs) on at least one of the slave devices. The illumination of one selected individual light-emitting diode notifies a recipient of the receipt of electronic mail (e-mail), by way of example.

After performing Step “S7”, the process either returns to Step “S2”, delays before returning to Step “S2”, or terminates.

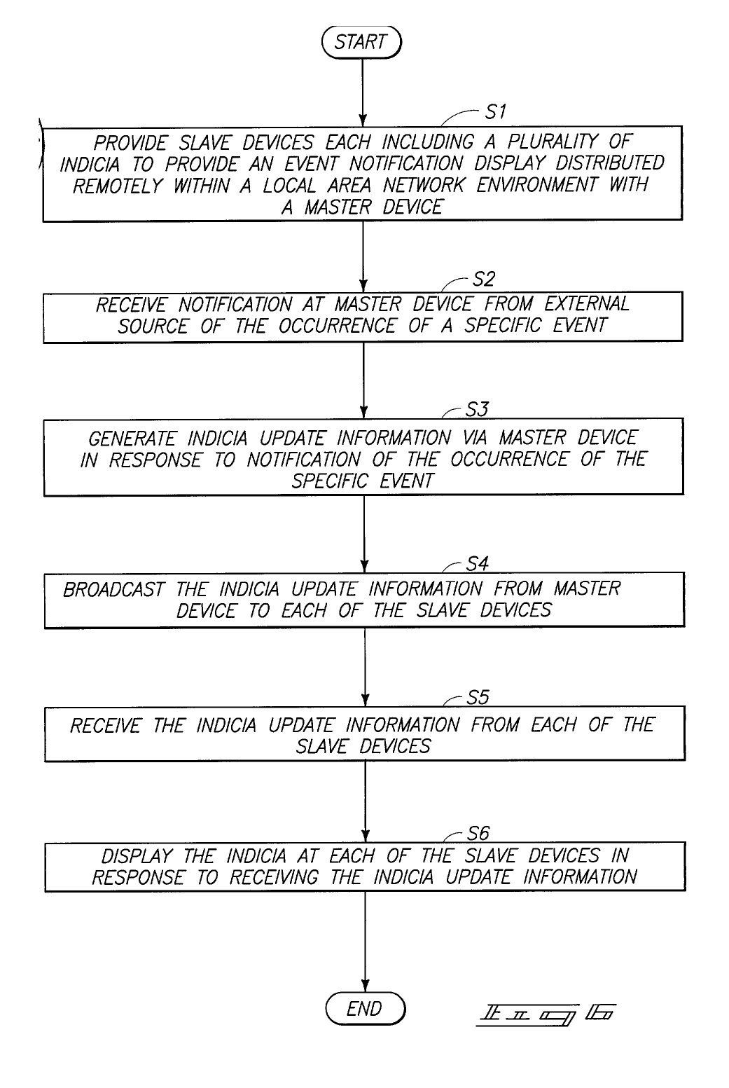

According to another implementation, FIG. 6 provides a logic flow diagram illustrating a method for displaying specific event notifications to a user within a local area network (LAN).

In Step “S1”, a plurality of slave devices are provided along with a master device. Each of the slave devices includes a plurality of indicia arranged to provide an event notification display. Distribution of such displays on such slave devices are distributed remotely within a local area network environment. The master device communicates with such slave devices via a communication link. The plurality of indicia includes an array of selectively illuminated light-emitting diodes (LEDs). A selected slave device includes a visual user interface including a unique indicia descriptor and a unique user identification tag associated with an LED of the array of LEDs. After performing Step “S1”, the process proceeds to Step “S2”.

In Step “S2”, the system receives notification at the master device from an external source of the occurrence of a specific event. After performing Step “S2”, the process proceeds to Step “S3”.

In Step “S3”, the system generates indicia update information via the master device in response to notification of the occurrence of the specific event. More particularly, the indicia update information is generated by generating at least one packet of information for transmission from the master device to the slave devices. The indicia includes an array of light-emitting diodes (LEDs). The packet of information includes illuminating information for turning on a selected one or more of the array of LEDs to visually represent a specific event notification to a selected user. After performing Step “S3”, the process proceeds to Step “S4”.

In Step “S4”, the system broadcasts the indicia update information from the master to each of the slave devices. After performing Step “S4”, the process proceeds to Step “S5”.

In Step “S5”, the system receives the indicia update information from each of the slave devices. After performing Step “S5”, the process proceeds to Step “S6”.

In Step “S6”, the system displays the indicia at each of the slave devices in response to receiving the indicia update information. More particularly, display of the indicia is implemented by turning on the LED in order to indicate to a recipient identified by the respective unique user identification of the occurrence of an event identified by the unique indicia descriptor. After performing Step “S6”, the process either returns to Step “S2”, delays before returning to Step “S2”, or terminates.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A distributed event notification system, comprising:
a master device having a transmitter, processing circuitry, and an interface, the interface communicating with a local area network (LAN) and configured to enable the master device to receive notification of events from one or more external event managers;
at least one slave device having a receiver and a user display; and
a communication link interconnecting the transmitter of the master device with the receiver of the at least one slave device;
wherein the master device transmits a packet of information from the master device to one or more slave devices via the communication link, the packet of information indicative of the notification of an event.

2. The event notification system of claim 1 wherein the communication link comprises a wired network link, the transmitter comprises a serial interface, and the receiver comprises a serial interface.

3. The event notification system of claim 1 wherein the communication link comprises a radio-frequency (RF) wireless network link, the transmitter comprises a transmitting antenna and transmitting circuitry, and the receiver comprises a receiver antenna and receiving circuitry.

4. The event notification system of claim 3 wherein the packet of information comprises a signature identification operative to validate the master device and the packet of information, and wherein the packet of information is transmitted after the signature identification.

5. The event notification system of claim 4 wherein information within the packet of information is encrypted.

6. The event notification system of claim 1 wherein the interface to the LAN comprises a universal serial bus (USB) circuit for coupling with a personal computer.

7. The event notification system of claim 1 wherein the interface to the LAN comprises an ethernet interface to enable the master device to directly reside on the local area network (LAN).

8. The event notification system of claim 1 wherein the user display of the slave device comprises a numerical clock display configured to display time from the slave device.

9. The event notification system of claim 8 wherein an external event manager communicates with a master clock, and each slave device comprises a slave clock, and wherein the packet of information comprises timing information for updating a reference time of each of the slave clocks based upon a reference time taken from the master clock.

10. The event notification system of claim 1 wherein the user display of the slave device comprises an array of light emitting diodes (LEDs) configured to display indicia representing the event notification information.

11. The event notification system of claim 10 wherein the indicia comprises a scheduled item.

12. The event notification system of claim 10 wherein the indicia comprises an email receipt notification.

13. The event notification system of claim 10 wherein the indicia comprises a failure of a system component that has been pre-selected by the user.

14. The event notification system of claim 1 wherein the master device communicates with a personal computer, and wherein the computer provides the user interface which is operative to configure the master device.

15. A method of notifying a recipient present within a local area of the occurrence of an event, comprising:
providing a master device and at least one slave device distributed within the local area and communicating with the master device;
receiving notification of occurrence of an event at the master device;
identifying at least one recipient for whom notification of the occurrence of the event is desired;
for the identified recipient, comparing the event with predefined selection criteria to determine if the event is a desired event;
if the event is a desired event, broadcasting a notification of the occurrence of the event to the at least one slave device from the master device; and
displaying indicia at the at least one slave device via a respective visual display in an effort to notify the recipient of the occurrence of the event.

16. The method of claim 15 further comprising detecting an occurrence of an event.

17. The method of claim 16 wherein comparing the event with predefined selection criteria comprises filtering the event to verify that the event is a desired event that necessitates notification of the recipient in response to occurrence of the event.

18. The method of claim 15 wherein broadcasting the notification of the event comprises transmitting at least one packet of information from the master device to the slave device.

19. The method of claim 18 wherein the packet of information is transmitted from a radio frequency (RF) transmitter to a radio frequency (RF) receiver.

20. The method of claim 15 wherein displaying indicia comprises illuminating selected individual light emitting diodes (LEDs) within an array of light emitting diodes (LEDs) on at least one of the slave devices.

21. The method of claim 15 wherein the indicia notify a recipient of the receipt of electronic mail.

22. The method of claim 21 wherein filtering the event comprises applying selection criteria to the event.

23. The method of claim 15 wherein the indicia represent a scheduled item for a recipient.

24. A method for displaying specific event notifications to a user within a local area network (LAN), comprising:
providing a plurality of slave devices each comprising a plurality of indicia arranged to provide an event notification display distributed remotely within a local area network environment along with a master device that communicates with each of the slave devices via a communication link;
receiving notification at the master device from an external source of the occurrence of a specific event;
generating indicia update information via the master device in response to notification of the occurrence of the specific event;
broadcasting the indicia update information from the master device to each of the slave devices;
receiving the indicia update information at each of the slave devices; and
displaying the indicia at each of the slave devices in response to receiving the indicia update information.

25. The method of claim 24 wherein the plurality of indicia comprises an array of selectively illuminated light emitting diodes (LEDs).

26. The method of claim 25 wherein a selected slave device comprises a visual user interface including a unique indicia descriptor and a unique user identification tag associated with an LED of the array of LEDs.

27. The method of claim 26 wherein displaying comprises turning on the LED to indicate to a recipient identified by the respective unique user identification tag of the occurrence of an event identified by the unique indicia descriptor.

28. The method of claim 24 wherein generating indicia update information comprises generating at least one packet of information for transmission from the master device to the slave devices.

29. The method of claim 28 wherein the indicia comprises an array of light emitting diodes (LEDs), and wherein the packet of information comprises illumination information for turning on a selected one or more of the array of LEDs to visually represent a specific event notification to a selected user.
